(19) United States
(12) Patent Application Publication
(10) Pub. No.: US 2019/0166427 A1
(43) Pub. Date: May 30, 2019

(54) SURROUND SOUND SYSTEMS FOR RECREATIONAL VEHICLES

(71) Applicant: Girard Guard, LLC, San Clemente, CA (US)

(72) Inventors: Johnnie Mathiasen, San Clemente, CA (US); Oscar Solis Marquez, San Clemente, CA (US)

(21) Appl. No.: 16/322,823

(22) PCT Filed: Aug. 3, 2017
(86) PCT No.: PCT/US2017/045337

§ 371 Date: Feb. 1, 2019

Related U.S. Application Data
(60) Provisional application No. 62/370,651, filed on Aug. 3, 2016.

(51) Int. Cl. H04R 5/02; E04F 10/06; H04S 3/00

(52) U.S. Cl. CPC H04R 5/02; H04S 2400/15; H04S 3/00; E04F 10/0666

(57) ABSTRACT

A surround sound system for use with a recreational vehicle (RV) having a TV having a TV screen exposed on a side of a body of the RV; one or more speakers arranged to emit sound located at or near the TV, and one or more speakers mounted to a retractable awning assembly. The plurality of speakers can be arranged to produce surround sound with front speakers and rear speakers. The surround sound system is configured for use to generate surround sound external of a body of the RV.

### FIELD OF THE ART

The present disclosure is generally related to music or audio/visual systems with specific discussions on surround sound system for recreational vehicles, such as surround sound systems for the outside of recreational vehicles, and related methods.

### BACKGROUND

Audio/visual entertainment systems are useful for recreational vehicles. Usually, audio/visual systems are mounted on the inside of the recreational vehicles. In this way, users can sit in the interior of the recreational vehicle and operate the system, similarly to being in a living room in a house.

### SUMMARY

The present disclosure relates to exterior audio/visual systems. Users can use these systems while outside of the recreational vehicle. Instead of being inside, users can sit outside and enjoy the weather while also using their audio/visual systems.

One or more embodiments provide a surround sound system for use with a recreational vehicle (RV) having a TV having a TV screen exposed on a side of a body of the RV, one or more speakers arranged to emit sound located at or near the TV, and one or more speakers mounted to a retractable awning assembly and spaced from the body of the RV.

Also, the surround sound system can have a sub-woofer connected to the one or more speakers.

Additionally, the surround sound system can provide wherein the one or more speakers mounted to the retractable awning assembly are mounted to a retractable frame of the retractable awning assembly.

Embodiments of the surround sound system can provide wherein the retractable frame comprises openings for mounting the one or more speakers mounted to the retractable awning assembly.

Some embodiments of the surround sound system can provide wherein power wires for the one or more speakers mounted to the retractable awning assembly are routed inside the retractable awning assembly.

Also, the surround sound system can provide wherein signal wires for the one or more speakers mounted to the retractable awning assembly are routed inside the retractable awning assembly.

One or more embodiments provide a method for creating a surround sound to an exterior of a recreational vehicle. The method can include providing a TV having a TV screen exposed on a side of a recreational vehicle, locating at least one speaker at or near the TV, and locating at least one speaker remote from the TV, wherein said at least one speaker remote from the TV is located with a retractable awning assembly.

Additionally, the method can provide wherein the at least one speaker remote from the TV is located with a retractable frame at an end closer to a free end of an awning fabric than a fixed end of the awning fabric.

One or more embodiments provide a surround sound system for use with a recreational vehicle (RV) having a retractable awning assembly. The surround sound system can include a first speaker and a second speaker located at or near a side of the RV and configured to emit sound towards a surround sound region, and a third and a fourth speaker mounted to the retractable awning assembly and configured to emit sound towards the surround sound region.

Also, the surround sound system can include a sub-woofer connected to the one or more speakers.

Some embodiments of the surround sound system can provide wherein the third and fourth speakers are mounted near a free end of the retractable awning assembly.

Additionally, the surround sound system can provide wherein the third and fourth speakers are mounted to openings in a retractable frame of the retractable awning assembly.

Some embodiments of the surround sound system can provide wherein power wires for the third and fourth speakers are routed inside the retractable awning assembly.

Embodiments of the surround sound system can provide wherein signal wires the third and fourth speakers are routed inside the retractable awning assembly.

Also, the surround sound system can include a fifth speaker and a sixth speaker, each respectively mounted at an intermediary position along support arms of the tractable awning assembly.

A surround sound system for use with a recreational vehicle (RV) can comprise one or more speakers arranged to emit sound located at or near the body of the RV; and one or more speakers mounted to a retractable awning assembly and spaced from the body of the RV. The one or more speakers spaced from the body of the RV can comprise a middle set of speakers located between two ends of the awning assembly, which can comprise an end mounted to the RV and a free end.

The one or more speakers spaced from the body of the RV can comprise a rear set of speakers located at or near the free end.

The one or more speakers spaced from the body of the RV can comprise both a middle set of speakers and a rear set of speakers.

The surround system can further comprise a TV having a TV screen exposed on a side of the RV, a projector for projecting a video image towards the RV, or both a TV and a projector.

A method for creating a surround sound to an exterior of a recreational vehicle comprising locating at least one speaker at or near a body of the RV and locating at least one speaker remote from the body of the RV; wherein said at least one speaker remote from the body of the RV is located with a retractable awning assembly.

The method can further include mounting a TV in an opening on a side of the RV.

A recreational vehicle may be any number of commercially available recreational vehicles, otherwise known as mobile homes or RVs. The RV has a body mounted on a chassis and driven by a plurality of wheels, which are all conventional. A plurality of windows are provided with the body of the RV, including the front shield or window and the rear shield or window.

An awning assembly is provided on a driver side of the body of the RV. A similar awning assembly can also be provided on the passenger side of the body of the RV. In an example, the awning assembly is a retractable type. In an example, the awning assembly 120 can include a motor for driving a retractable frame, such as one or more rollers, articulating arms, and pivotable hinges, having an awning fabric attached to the frame.

The awning fabric of the awning system can be rolled into a packed roll of fabric with one or more rollers, which can be motorized to automatically roll or expand the awning fabric. When the awning fabric is expanded, such as to provide shades, the retractable frame expands to support the free end of the awning fabric, as further discussed below. The awning assembly can be activated with a switch, which can be wall mounted or on a remote control.

A retractable television (“TV”) storage assembly can also be provided on the driver side of the RV. In an example, the TV storage assembly comprises a door for enclosing an opening, which can be part of a cabinet or frame provided on the side of the RV.

The door of the TV storage assembly can be motorized to swing open or close. For example, the door can be activated so that a motor rotates the free end of the door to swing up to expose the interior of the TV storage assembly 130.

The awning assembly can be activated so that the awning fabric extends outwardly from the driver side of the RV and the door of the TV storage assembly has been raised.

In other examples, the location of the awning assembly and the TV storage assembly can be located elsewhere, such as on the passenger side of the body of the RV. In some examples, the RV can have an awning assembly and a TV storage assembly on both sides of the body of the RV.

The awning fabric has a free end that extends away from the RV and an attached end. The attached end of the awning fabric is attached to the awning assembly housing.

The free end and the awning fabric can be held in the extended position by a retractable frame. An exemplary awning assembly with the disclosed capabilities is available from Girard Products, Girard Systems, or both, located in San Clemente, Calif.

The RV can have the awning assembly and the TV storage assembly both activated. The television (TV) can be located within the opening of the TV storage assembly, which is exposed when the door is activated to open. The TV can be any number of commercially available televisions. The TV should be of the type that is rated for outdoor use.

In an example, a surround sound system can be provided for use with the TV. The surround sound system is configured for use with a recreational vehicle.

In a particular example, the sound system is configured for use on an outside of the body of the RV. The sound system can comprise a surround sound system. The surround sound system of the present disclosure can comprise the following arrangements or configurations:

(1) a front center (FC) speaker, a front left (FL) speaker, a front right (FR) speaker, a rear left (RL) speaker, and a rear right (RR) speaker,

(2) FC speaker, FL speaker, FR speaker, RL speaker, RR speaker, and a rear center (RC) speaker,

(3) FC speaker, FL speaker, FR speaker, RL speaker, RR speaker, middle left (ML) speaker, and middle right (MR) speaker, or

(4) FC speaker, FL speaker, FR speaker. Other surround sound arrangements are contemplated. Further, a sub-woofer SW can also be provided with the surround sound system.

The surround sound system is shown with a plurality of speakers, as noted by the acronyms FL, FC, FR, ML, MR, RL, RC, and RR. In an example, any of the noted surround sound configurations can include mounting several speakers with the TV storage assembly.

The speakers can be mounted below the TV, above the TV, or to the side(s) of the TV. In some examples, the FL and FR speakers can be located above and to the sides of the TV, such as near the housing of the awning assembly.

The speakers, including the sub-woofer if incorporated, should be selected or rated for outdoor use.

The rear and/or side speakers, ML, MR, RL, RC, and/or RR speakers, can be mounted to the awning assembly. In an example, the speakers are connected to one of the frames, rods, or support bars on the retractable frame of the awning assembly. In some examples, the retractable frame assembly is wired with speaker wires, including near the housing of the awning assembly for mounting the FL, FC, and/or FR speakers, and the speakers are mounted to the awning assembly and connected to the speaker wires once the awning assembly is activated and the awning fabric extended.

In still other examples, wireless speakers are used so that no speaker wires are routed through the awning assembly. In yet other examples, power lines are provided within the awning assembly to power the wireless speakers.

The surround sound system can be wired to an audio and video system of the RV. The surround sound system can be activated remotely and can produce surround sound in an area external to the body of the RV. Said differently, at least two or more speakers can be mounted externally of the body of the RV for use in a surround sound system external of the RV. The surround sound system is configured for use with a TV having a display screen exposed on a side of an RV.

An aspect of the present disclosure includes an audio system for use exteriorly of an RV. In an example, one or more speakers are mounted at a location spaced from the body of the RV for use with audio and/or video equipment, such as a tuner, an amplifier, a DVD player, a satellite receiver, or combinations thereof.

The speakers can be located on an awning frame of an awning assembly at locations remote from the body of the RV.

Optionally, a first set of multiple speakers can be located adjacent the body of the RV or in connection with an exterior body wall of the RV, such as in a TV storage assembly of the RV, at the awning housing mounted to the RV, or near the awning housing mounted to the RV. In some examples, an FC speaker is mounted next to a TV and the FL and FR speakers are mounted at or near an awning housing of an awning assembly.

A second set of multiple speakers can be located remote from the first set of multiple speakers and spaced from the body of the RV. A third set of multiple speakers can be located remote from the second set of multiple speakers and remote from the body of the RV.

In an example, the first set of multiple speakers can comprise FL, FC, and FR speakers. In an example, the second set of multiple speakers can comprise ML and MR speakers.

In an example, the third set of multiple speakers can comprise RL, RC, and RR speakers.

In an example, the audio system omits the second set of multiple speakers. The audio system is configured to produce surround sound from audio equipment and/or video equipment mounted in or with the body of the RV.

The speakers of the surround sound system can be mounted to a retractable frame of the awning assembly through a mounting system. For example, the mounting system can be mounting brackets that are installed on the frame. The mounting brackets can be designed such that they do not interfere with the operation of the awning assembly.

Speakers ML, MR, RL, RC, and RR can then be attached to the mounting brackets 400 when the awning assembly is deployed.

In an alternative embodiment, the mounting system can include provisions, such as brackets, for mounting FL and FR speakers, and optionally also for mounting an FC speaker. The mounting brackets can be attached at various points along the retractable frame, such as near the ends of the support arms.

The surround sound system can comprise the following arrangement of a front left (FL) speaker, a front right (FR) speaker, front center left (FCL) speaker, front center right (FCR) speaker, a middle left (ML) speaker, a middle right (MR) speaker, a rear left (RL) speaker, a rear center (RC) speaker, a rear right (RR) speaker, and a sub-woofer (SW).

An exemplary SW unit can be a flat SW for use as a built-in unit or a freestanding SW unit that can be repositioned or located as desired.

The mounting brackets can have openings for a hook or protrusion on the speakers for hanging of the speakers. The brackets and the speakers can have corresponding fastening components, such as quarter-turn fasteners, for mounting.

The mounting bracket can be attached to the support arm by fastening, welding, gluing, or integral forming. The mounting bracket can have an opening for mounting a speaker.

Although the exemplary opening is circular, other shapes can be used as desired, such as rectangular, square, or elliptical.

In other examples, projections or hooks can be incorporated with the frame of the mounting assembly and the speakers can be mounted to the projections or hooks. Each mounting location for a speaker can also incorporate different mounting types to provide alternative mounting options.

For example, each mounting location can have a combination of two or more of the following mounting types: an opening, a projection, a hook, a wire, a detent, a pocket, a ball joint, a hinge, etc. In some examples, a magnetic mount or a suction mount may be used.

The front speakers can be mounted separately from the TV storage assembly. The front speakers can be individual and independently mounted speakers on the side of the RV or they can be an integral sound bar.

In embodiments, the surround sound system is operable independently of a video source, such as a TV or projector. The surround sound system may be configured to play audio without a video component.

In this way, the front speakers can be used for exterior audio without having to open the door of the TV storage assembly or even deployment of the awning assembly with deployment of the awning being optional to provide shade.

Additionally, the sub-woofer SW can also be a standalone unit that can be placed separate or spaced from the RV.

All of the speakers may be hardwired to the RV.

Alternatively, some or all of the speakers can be independently powered, such as by a battery or external power source.

Communication signals for the individual speakers can also be accomplished by hardwired connection or by wireless means.

In other examples, different surround sound speaker combinations are used.

Embodiments of the surround sound system can have the power and communication signals for some or all of the speakers provided by wiring inside or along the retractable frame.

For the sub-woofer SW, a wiring connection point can be provided along the retractable frame if a hardwired connection is desired. This can provide a vertical wiring path 10 for the sub-woofer SW and potentially lessen a tripping risk as compared to running wire from the RV to an external sub-woofer SW.

The speakers ML, MR, RL, RC, and RR can be built into the awning frame. Such a configuration can provide a sleek appearance and can simplify design without concern for affecting the operation of the awning assembly.

The speakers can have power and/or communication signals, such as one or the other or both, provided by wiring inside or along the retractable frame.

For an external sub-woofer SW, a wiring connection point can be provided along the retractable frame if a hardwired connection is desired. In some examples, only power cabling is provided for the speakers if wireless speakers are utilized.

The awning frame can have cut-outs or openings sized for the speakers.

The speakers can be substantially flush mounted with a surface of the awning frame. In this way, the awning assembly operation can be unaffected by the inclusion of the speakers. There is no concern for retracting of the awning assembly and potentially damaging either hanging speakers or the awning assembly itself.

The awning frame of the awning assembly can be sized to have sufficient strength to withstand necessary loads regardless of the inclusion of the speakers, or other or different combinations of speakers.

In this way, the awning frame can be provided on vehicles with the potential for a surround sound system upgrade.

Alternatively, the awning frame of the awning assembly can use the structures of the speakers as stressed structural members of the awning assembly.

In this way, the speakers can be attached to the awning frame such that loads on the awning frame also are distributed to the speakers.

In embodiments, the speakers can fit into corresponding cut-outs or openings of the awning frame.

Alternatively, the speakers may themselves act as intermediary joining sections between sections of the awning frame. That is, sections of the awning frame can be attached to speaker to form the awning assembly without a continuous awning frame at the location of the speaker. The use of the speakers as stressed structural members can provide for a slimmer awning frame.

By having the speakers mounted flush to the awning frame, the deployment and retraction of the awning assembly can be undisturbed by the inclusion of the speakers.

The surround sound system can be mounted to the awning fabric of the awning assembly.

The surround sound system can be paired with a projector and projector screen instead of a TV.

The speakers ML, MR, RL, and RR, or other combinations of speakers or other speaker configurations, can be attached to the awning assembly by way of holes in the awning fabric.

The holes can be grommeted holes, or otherwise reinforced, in order to prevent the awning fabric from becoming damaged from use of the surround sound system.

The use of holes on the awning fabric can allow for minimal replacement cost to install a surround sound system as compared to replacing the awning assembly when retrofitting an RV. A new awning system can also be equipped with reinforced awning fabric for use with the surround sound system of the present disclosure rather than a retrofitted awning system.

The speakers, ML, MR, RL, and RR, or other speaker configurations or other speaker combinations, can then be mounted to the holes, such as by hanging from hooks or a variation of a toggle bolt. Speaker RC can be attached to a mounting bracket or similarly attached by way of a hole.

A projector can be provided to project towards the RV from the free end of the awning assembly. The projector can be mounted to the awning assembly by way of a mounting bracket. The speaker RC and the projector can be mounted on a singular mounting bracket or on separate mounting brackets.

The awning assembly may having wiring for power and communication signals for the speakers ML, MR, RL, RC, RR and SW and the projector. The sub-woofer SW can also be a standalone unit that can be placed separate from the RV. The wiring may extend along the awning fabric or it may extend inside or along an awning frame of the awning assembly.

All of the speakers FL, FCL, FCR, FR, ML, MR, RL, RC, RR, and SW may be hardwired to the RV. Alternatively, some or all of the speakers FL, FCL, FCR, FR, ML, MR, RL, RC, RR, and SW can be independently powered, such as by a battery or external power source.

Communication signals for the individual speakers can also be accomplished by hardwired connection or by wireless means. For the sub-woofer SW, a wiring connection point can be provided along the retractable frame if a hardwired connection is desired. This can provide a vertical wiring path for the sub-woofer SW and potentially lessen a tripping risk as compared to running wire from the RV to an external sub-woofer SW.

In embodiments, the holes can be provided in an awning frame for hanging speakers. The use of holes can avoid the necessity of additional mounting brackets. There can be an opening in a support arm of the awning frame that a speaker can be hung from.

The front speakers can also be mounted to the awning assembly at points close to the RV or mounted to the side of the RV. Front holes can be provided and used for the mounting of the front speakers.

The front holes can be placed closer together for the mounting of the front speakers in the form of a sound bar or spaced apart for individual speakers.

Variations of the mounting of the speakers FL, FCL, FCR, FR, ML, MR, RL, RC, RR, and SW may be applied as a single type of mounting for an entire surround sound system, or mixed and matched as desired.

For example, in scenarios where wireless, preset speakers are to be hung by the user, using different mounting types between the positions can ensure that the speakers are correctly positioned without guesswork as to the proper placement of the individual speakers.

Also, the listing of the speakers is not exhaustive for use in a surround sound system 200. Alternative arrangements and choices of speakers can be used in addition to the identified speakers FL, FCL, FCR, FR, ML, MR, RL, RC, RR, and SW.

Arrangements using fewer speakers, such as for 5.1 (five speakers, one sub-woofer) surround sound arrangements can be formed.

In embodiments, the surround sound system is used with a projector device. The projector device can project an image upon the side of the RV or upon another surface, such as a portable projector screen. In embodiments, the RV may have a retractable screen attached to the side of the TV or attached to the end of the awning.

Alternatively, the awning may have attachment points for mounting a projector screen on the free end of the awning or along a side of the awning. The projector may be attached to the RV or the awning in a suitable location for projecting onto the projector screen.

Alternatively, the projector can be removeably attached to the RV for projection.

Methods of making and of using the audio surround sound system, video system, and both systems are understood to be within the scope of the present invention.

The projector may be either hardwired to the surround sound system, or it may be wirelessly connected to the surround sound system.

### BRIEF DESCRIPTION OF THE DRAWINGS

These and other features and advantages of the present device, system, and method will become appreciated as the same becomes better understood with reference to the specification, claims and appended drawings wherein:

FIG. 1 shows a schematic view of a recreational vehicle with a retractable awning and a television storage assembly.

FIG. 2 shows a rear view of a recreational vehicle with a retractable awning assembly and a television storage assembly.

FIG. 3 shows a schematic view of a recreational vehicle with a surround sound system mounted to the recreational vehicle and to the awning assembly.

FIG. 4 shows a schematic view of a recreational vehicle with a surround sound system mounted to the recreational vehicle and to the awning assembly by way of brackets.

FIG. 5 shows a rear view of a recreational vehicle with integrated speakers for a surround sound system integrated into the awning assembly.

FIG. 6 shows a schematic view of a recreational vehicle with a projector and a surround sound system mounted to the recreational vehicle and to the awning assembly.

FIGS. 7A and 7B show exemplary mounts for speakers with the awning assembly.

### DETAILED DESCRIPTION

The detailed description set forth below in connection with the appended drawings is intended as a description of the presently preferred embodiments of surround sound systems provided in accordance with aspects of the present devices, systems, and methods and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

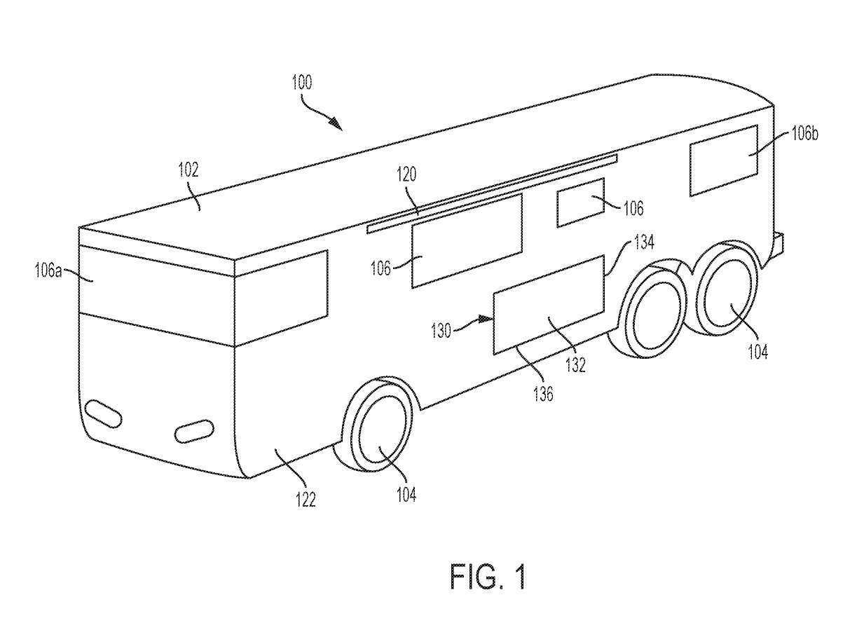

FIG. 1 is a schematic view of a recreational vehicle 100, which may be any number of commercially available recreational vehicles, otherwise known as mobile homes or RVs. The RV 100 has a body 102 mounted on a chassis and driven by a plurality of wheels 104, which are all conventional. A plurality of windows 106 are provided with the body 102 of the RV 100, including the front shield or window 106a and the rear shield or window 106b.

As shown, an awning assembly 120 is provided on a driver side 122 of the body 102 of the RV 100. A similar awning assembly 120 can also be provided on the passenger side of the body of the RV. In an example, the awning assembly 120 is a retractable type. In an example, the awning assembly 120 can include a motor for driving a retractable frame, such as one or more rollers, articulating arms, and pivotable hinges, having an awning fabric attached to the frame. The awning fabric of the awning system can be rolled into a packed roll of fabric with one or more rollers, which can be motorized to automatically roll or expand the awning fabric. When the awning fabric is expanded, such as to provide shades, the retractable frame expands to support the free end of the awning fabric, as further discussed below. The awning assembly 120 can be activated with a switch, which can be wall mounted or on a remote control.

A retractable television (“TV”) storage assembly 130 can also be provided on the driver side 122 of the RV 100. In an example, the TV storage assembly 130 comprises a door 132 for enclosing an opening 134, which can be part of a cabinet or frame provided on the side of the RV. The door 132 of the TV storage assembly 130 can be motorized to swing open or close. For example, the door 132 can be activated so that a motor rotates the free end 136 of the door 132 to swing up to expose the interior of the TV storage assembly 130. Additional information regarding the TV storage assembly 130 is provided in U.S. Provisional Application No. 62/261,677, filed Dec. 1, 2015, and PCT Application No. PCT/US2016/064465, filed Dec. 1, 2016, entitled MOTORIZED DOORS AND RELATED METHODS, the contents of which are expressly incorporated herein by reference.

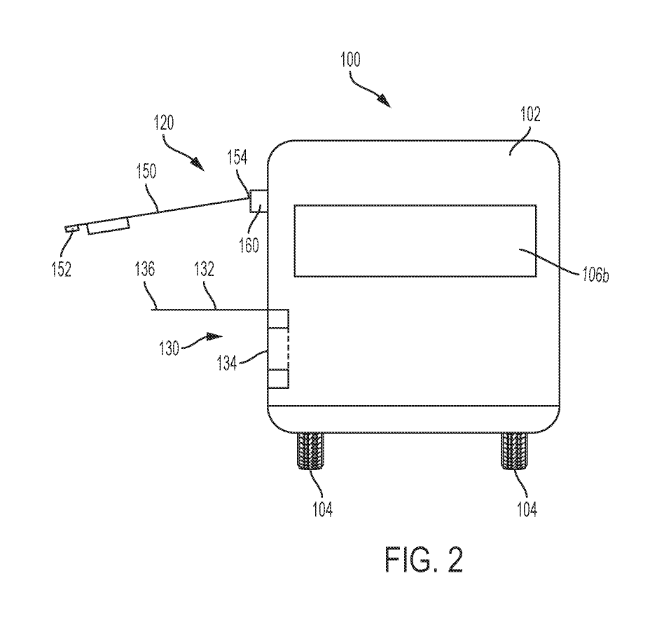

With reference now to FIG. 2, a rear view of the RV 100 of FIG. 1 is shown with the awning assembly 120 and the TV storage assembly 130 both activated. As shown, the awning assembly 120 is activated so that the awning fabric 150 extends outwardly from the driver side 122 of the RV and the door 132 of the TV storage assembly 130 has been raised. In other examples, the location of the awning assembly and the TV storage assembly can be located elsewhere, such as on the passenger side of the body of the RV. In some examples, the RV 100 can have an awning assembly and a TV storage assembly on both sides of the body of the RV.

As shown, the awning fabric 150 has a free end 152 that extends away from the RV and an attached end 154. The attached end 154 of the awning fabric 150 is attached to the awning assembly housing 160. The free end 152 and the awning fabric 150 can be held in the extended position by a retractable frame. An exemplary awning assembly 120 with the disclosed capabilities is available from Girard Products, Girard Systems, or both, located in San Clemente, Calif.

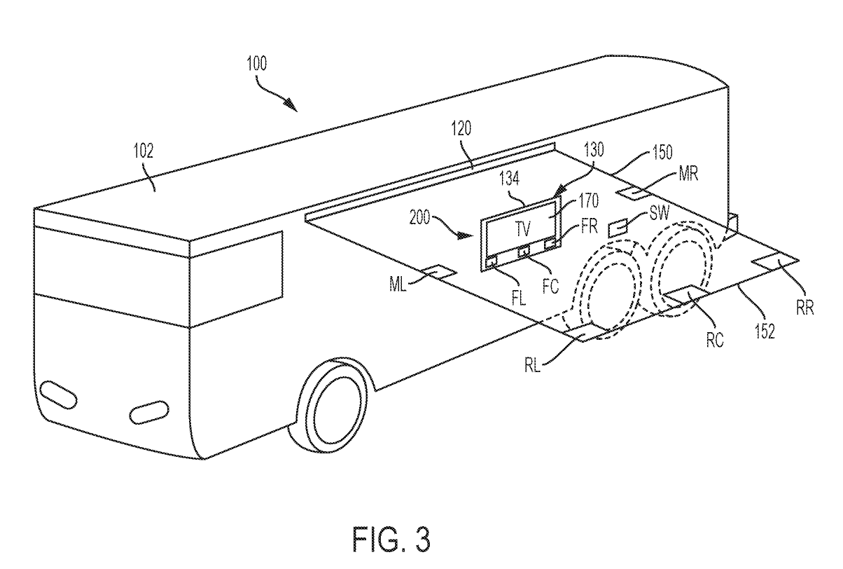

With reference now to FIG. 3, a schematic perspective view of the RV 100 of FIG. 2 is shown, which shows the awning assembly 120 and the TV storage assembly 130 both activated. Also shown is a television (TV) 170 located within the opening 134 of the TV storage assembly 130, which is exposed when the door 132 is activated to open. The TV can be any number of commercially available televisions. The TV should be of the type that is rated for outdoor use.

In an example, a surround sound system 200 can be provided for use with the TV 170. The surround sound system 200 is configured for use with a recreational vehicle 100. In a particular example, the sound system 200 is configured for use on an outside of the body 102 of the RV. The sound system 200 can comprise a surround sound system. The surround sound system 200 of the present disclosure can comprise the following arrangements or configurations: (1) a front center (FC) speaker, a front left (FL) speaker, a front right (FR) speaker, a rear left (RL) speaker, and a rear right (RR) speaker, (2) FC speaker, FL speaker, FR speaker, RL speaker, RR speaker, and a rear center (RC) speaker, (3) FC speaker, FL speaker, FR speaker, RL speaker, RR speaker, middle left (ML) speaker, and middle right (MR) speaker, or (4) FC speaker, FL speaker, FR speaker. Other surround sound arrangements are contemplated. Further, a sub-woofer SW can also be provided with the surround sound system.

With particular reference to FIG. 3, the surround sound system 200 is shown with a plurality of speakers, as noted by the acronyms FL, FC, FR, ML, MR, RL, RC, and RR. In an example, any of the noted surround sound configurations can include mounting several speakers with the TV storage assembly 130. The speakers can be mounted below the TV 170, above the TV, or to the side(s) of the TV. In some examples, the FL and FR speakers can be located above and to the sides of the TV 170, such as near the housing of the awning assembly 120. The speakers, including the sub-woofer if incorporated, should be selected or rated for outdoor use.

The rear and/or side speakers, ML, MR, RL, RC, and/or RR speakers, can be mounted to the awning assembly 120. In an example, the speakers are connected to one of the frames, rods, or support bars on the retractable frame of the awning assembly. In some examples, the retractable frame assembly is wired with speaker wires at one of the locations shown in FIG. 3, including near the housing of the awning assembly for mounting the FL, FC, and/or FR speakers, and the speakers are mounted to the awning assembly and connected to the speaker wires once the awning assembly 120 is activated and the awning fabric extended as shown. In still other examples, wireless speakers are used so that no speaker wires are routed through the awning assembly. In yet other examples, power lines are provided within the awning assembly to power the wireless speakers.

The surround sound system 200 can be wired to an audio and video system of the RV 100. The surround sound system 200 can be activated remotely and can produce surround sound in an area external to the body of the RV. Said differently, at least two or more speakers can be mounted externally of the body of the RV for use in a surround sound system external of the RV. The surround sound system 200 is configured for use with a TV having a display screen exposed on a side of an RV.

An aspect of the present disclosure includes an audio system for use exteriorly of an RV. In an example, one or more speakers are mounted at a location spaced from the body of the RV for use with audio and/or video equipment, such as a tuner, an amplifier, a DVD player, a satellite receiver, or combinations thereof. The speakers can be located on an awning frame of an awning assembly at locations remote from the body of the RV. Optionally, a first set of multiple speakers can be located adjacent the body of the RV or in connection with an exterior body wall of the RV, such as in a TV storage assembly 130 of the RV, at the awning housing mounted to the RV, or near the awning housing mounted to the RV. In some examples, an FC speaker is mounted next to a TV and the FL and FR speakers are mounted at or near an awning housing of an awning assembly.

A second set of multiple speakers can be located remote from the first set of multiple speakers and spaced from the body of the RV. A third set of multiple speakers can be located remote from the second set of multiple speakers and remote from the body of the RV. In an example, the first set of multiple speakers can comprise FL, FC, and FR speakers. In an example, the second set of multiple speakers can comprise ML and MR speakers. In an example, the third set of multiple speakers can comprise RL, RC, and RR speakers. In an example, the audio system omits the second set of multiple speakers. The audio system is configured to produce surround sound from audio equipment and/or video equipment mounted in or with the body of the RV.

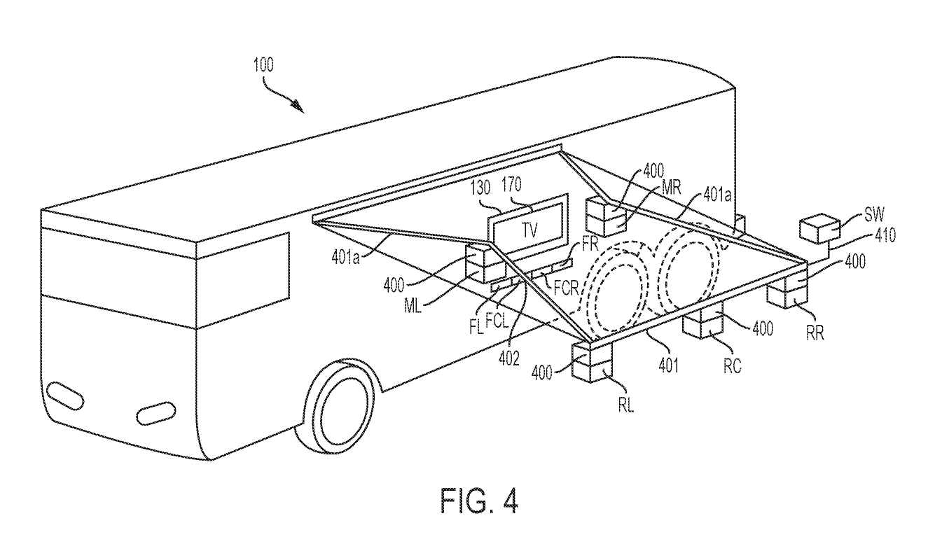

FIG. 4 shows a schematic view where speakers of the surround sound system 200 can be mounted to a retractable frame 401 of the awning assembly 120 through a mounting system. For example, the mounting system can be mounting brackets 400 that are installed on the frame 401. The mounting brackets 400 can be designed such that they do not interfere with the operation of the awning assembly 120. Speakers ML, MR, RL, RC, and RR can then be attached to the mounting brackets 400 when the awning assembly 120 is deployed. In an alternative embodiment, the mounting system can include provisions, such as brackets, for mounting FL and FR speakers, and optionally also for mounting an FC speaker. The mounting brackets can be attached at various points along the retractable frame 401, such as near the ends of the support arms 401a.

The surround sound system 200 of FIG. 4 can comprise the following arrangement of a front left (FL) speaker, a front right (FR) speaker, front center left (FCL) speaker, front center right (FCR) speaker, a middle left (ML) speaker, a middle right (MR) speaker, a rear left (RL) speaker, a rear center (RC) speaker, a rear right (RR) speaker, and a sub-woofer (SW). An exemplary SW unit can be a flat SW for use as a built-in unit or a freestanding SW unit that can be repositioned or located as desired.

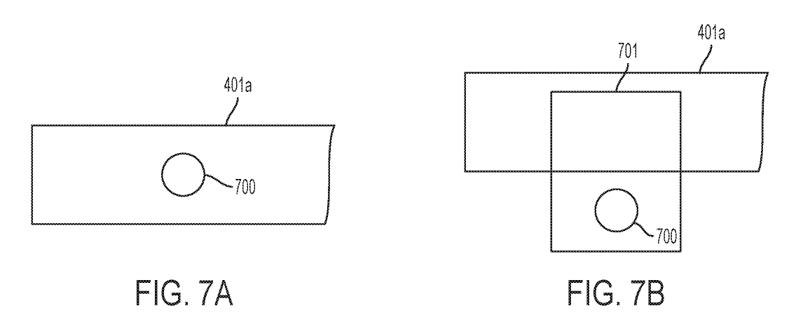

The mounting brackets can have openings for a hook or protrusion on the speakers for hanging of the speakers. The brackets and the speakers can have corresponding fastening components, such as quarter-turn fasteners, for mounting. An exemplary mounting bracket 701 is provided in FIG. 7B. The mounting bracket 701 can be attached to the support arm 401a by fastening, welding, gluing, or integral forming. The mounting bracket 701 can have an opening 700 for mounting a speaker. Although the exemplary opening is circular, other shapes can be used as desired, such as rectangular, square, or elliptical. In other examples, projections or hooks can be incorporated with the frame of the mounting assembly and the speakers can be mounted to the projections or hooks. Each mounting location for a speaker can also incorporate different mounting types to provide alternative mounting options. For example, each mounting location can have a combination of two or more of the following mounting types: an opening, a projection, a hook, a wire, a detent, a pocket, a ball joint, a hinge, etc. In some examples, a magnetic mount or a suction mount may be used.

The front speakers FL, FCL, FCR, FR can be mounted separately from the TV storage assembly 130. The front speakers FL, FCL, FCR, FR can be individual and independently mounted speakers on the side of the RV or they can be an integral sound bar 402. In embodiments, the surround sound system 200 is operable independently of a video source, such as a TV or projector. The surround sound system 200 may be configured to play audio without a video component. In this way, the front speakers 402 can be used for exterior audio without having to open the door 132 of the TV storage assembly 130 or even deployment of the awning assembly 120 with deployment of the awning being optional to provide shade.

Additionally, although the sub-woofer SW of FIG. 3 is mounted to the RV, the sub-woofer SW can also be a standalone unit that can be placed separate or spaced from the RV. All of the speakers FL, FCL, FCR, FR, ML, MR, RL, RC, RR, and SW may be hardwired to the RV. Alternatively, some or all of the speakers FL, FCL, FCR, FR, ML, MR, RL, RC, RR, and SW can be independently powered, such as by a battery or external power source. Communication signals for the individual speakers can also be accomplished by hardwired connection or by wireless means. In other examples, different surround sound speaker combinations are used.

Embodiments of the surround sound system 200 can have the power and communication signals for some or all of the speakers ML, MR, RL, RC, RR, and SW provided by wiring inside or along the retractable frame 401. For the sub-woofer SW, a wiring connection point can be provided along the retractable frame 401 if a hardwired connection is desired. This can provide a vertical wiring path 410 for the sub-woofer SW and potentially lessen a tripping risk as compared to running wire from the RV 100 to an external sub-woofer SW.

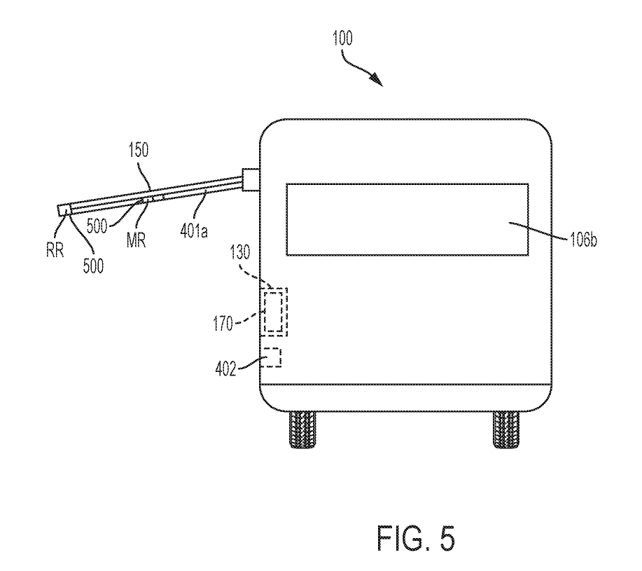

FIG. 5 shows a rear view of the RV with integrated speakers MR, RR. The other speakers ML, RL, RC can be understood as being illustratively behind the two shown speakers and configured in similar fashion.

In FIG. 5, the speakers ML, MR, RL, RC, and RR are built into the awning frame 401. Such a configuration can provide a sleek appearance and can simplify design without concern for affecting the operation of the awning assembly.

The speakers can have power and/or communication signals, such as one or the other or both, provided by wiring inside or along the retractable frame 401. For an external sub-woofer SW, a wiring connection point can be provided along the retractable frame 401 if a hardwired connection is desired. In some examples, only power cabling is provided for the speakers if wireless speakers are utilized.

The awning frame 401 can have cut-outs or openings 500 sized for the speakers ML, MR, RL, RC, and RR. The speakers ML, MR, RL, RC, and RR can be substantially flush mounted with a surface of the awning frame 401. In this way, the awning assembly 120 operation can be unaffected by the inclusion of the speakers. There is no concern for retracting of the awning assembly and potentially damaging either hanging speakers or the awning assembly itself.

The awning frame 401 of the awning assembly 120 can be sized to have sufficient strength to withstand necessary loads regardless of the inclusion of the speakers ML, MR, RL, RC, and RR, or other or different combinations of speakers. In this way, the awning frame 401 can be provided on vehicles with the potential for a surround sound system upgrade. Alternatively, the awning frame 401 of the awning assembly 120 can use the structures of the speakers as stressed structural members of the awning assembly 120. In this way, the speakers can be attached to the awning frame 401 such that loads on the awning frame 401 also are distributed to the speakers. In embodiments, the speakers can fit into corresponding cut-outs or openings 500 of the awning frame 401. Alternatively, the speakers may themselves act as intermediary joining sections between sections of the awning frame 401. That is, sections of the awning frame 401 can be attached to speaker to form the awning assembly 120 without a continuous awning frame 401 at the location of the speaker. The use of the speakers as stressed structural members can provide for a slimmer awning frame 401.

By having the speakers mounted flush to the awning frame 401, the deployment and retraction of the awning assembly can be undisturbed by the inclusion of the speakers.

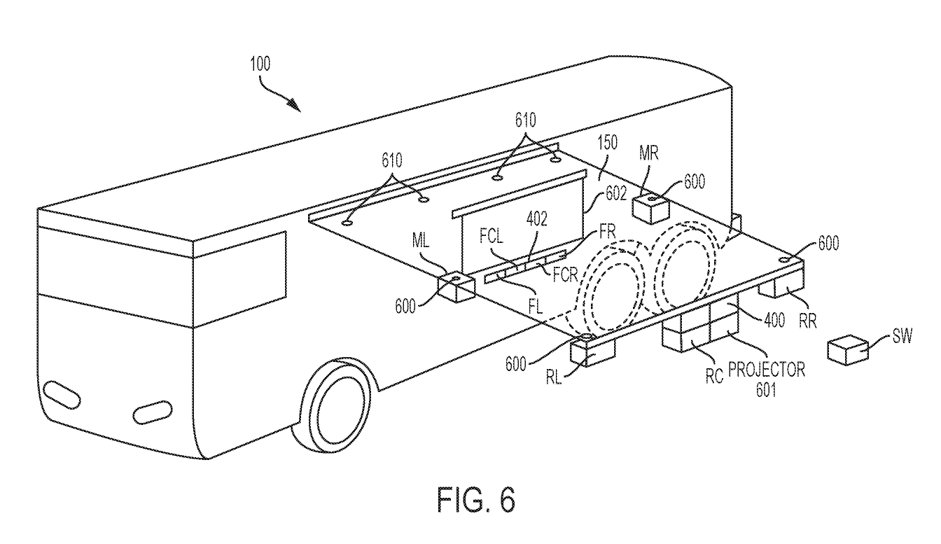

FIG. 6 shows a schematic view where speakers of the surround sound system 200 can be mounted to the awning fabric 150 of the awning assembly 120. The surround sound system 200 can be paired with a projector 601 and projector screen 602 instead of a TV.

The speakers ML, MR, RL, and RR, or other combinations of speakers or other speaker configurations, can be attached to the awning assembly by way of holes 600 in the awning fabric 150. The holes 600 can be grommeted holes, or otherwise reinforced, in order to prevent the awning fabric 150 from becoming damaged from use of the surround sound system 200. The use of holes 600 on the awning fabric 150 can allow for minimal replacement cost to install a surround sound system 200 as compared to replacing the awning assembly 120 when retrofitting an RV. A new awning system can also be equipped with reinforced awning fabric for use with the surround sound system 200 of the present disclosure rather than a retrofitted awning system.

The speakers, ML, MR, RL, and RR, or other speaker configurations or other speaker combinations, can then be mounted to the holes 600, such as by hanging from hooks or a variation of a toggle bolt. In the illustrated embodiment, speaker RC is shown attached to a mounting bracket 400. However, the speaker RC may be similarly attached by way of a hole 600.

In FIG. 6, a projector 601 is provided to project towards the RV from the free end 152 of the awning assembly 120. The projector 601 can be mounted to the awning assembly 120 by way of a mounting bracket 400. The speaker RC and the projector 601 can be mounted on a singular mounting bracket 400 or on separate mounting brackets 400.

The awning assembly 120 may having wiring for power and communication signals for the speakers ML, MR, RL, RC, RR and SW and the projector 601. The sub-woofer SW can also be a standalone unit that can be placed separate from the RV. The wiring may extend along the awning fabric 150 or it may extend inside or along an awning frame of the awning assembly 120.

All of the speakers FL, FCL, FCR, FR, ML, MR, RL, RC, RR, and SW may be hardwired to the RV. Alternatively, some or all of the speakers FL, FCL, FCR, FR, ML, MR, RL, RC, RR, and SW can be independently powered, such as by a battery or external power source. Communication signals for the individual speakers can also be accomplished by hardwired connection or by wireless means. For the sub-woofer SW, a wiring connection point can be provided along the retractable frame 401 if a hardwired connection is desired. This can provide a vertical wiring path 410 for the sub-woofer SW and potentially lessen a tripping risk as compared to running wire from the RV 100 to an external sub-woofer SW.

In embodiments, the holes 600 can be provided in an awning frame 401 for hanging speakers. The use of holes can avoid the necessity of additional mounting brackets 400. FIG. 7A shows an opening 700 in a support arm 401a of the awning frame 401 that a speaker can be hung from.

Additionally, although the illustrations show the front speakers as being mounted in the RV, the front speakers can also be mounted to the awning assembly 120 at points close to the RV or mounted to the side of the RV. For example, front holes 610 can be provided and used for the mounting of the front speakers. The front holes 610 can be placed closer together for the mounting of the front speakers in the form of a sound bar or spaced apart for individual speakers.

In the illustrations shown, variations of the mounting of the speakers FL, FCL, FCR, FR, ML, MR, RL, RC, RR, and SW may be applied as a single type of mounting for an entire surround sound system, or mixed and matched as desired. For example, in scenarios where wireless, preset speakers are to be hung by the user, using different mounting types between the positions can ensure that the speakers are correctly positioned without guesswork as to the proper placement of the individual speakers.

Also, the listing of the speakers is not exhaustive for use in a surround sound system 200. Alternative arrangements and choices of speakers can be used in addition to the identified speakers FL, FCL, FCR, FR, ML, MR, RL, RC, RR, and SW. Arrangements using fewer speakers, such as for 5.1 (five speakers, one sub-woofer) surround sound arrangements can be formed.

As shown, in embodiments, the surround sound system is used with a projector device. The projector device can project an image upon the side of the RV or upon another surface, such as a portable projector screen. In embodiments, the RV may have a retractable screen attached to the side of the TV or attached to the end of the awning. Alternatively, the awning may have attachment points for mounting a projector screen on the free end 152 of the awning or along a side of the awning. The projector may be attached to the RV or the awning in a suitable location for projecting onto the projector screen. Alternatively, the projector can be removeably attached to the RV for projection. The projector may be either hardwired to the surround sound system 200, or it may be wirelessly connected to the surround sound system 200.

Although limited embodiments of surround sound systems and their components have been specifically described and illustrated herein, many modifications and variations will be apparent to those skilled in the art. For example, the FL, FC, and FR speakers can be mounted elsewhere of the TV storage assembly 130, such as outside of the opening of the TV storage assembly. Accordingly, it is to be understood that the surround sound system and their components constructed according to principles of the disclosed devices, systems, and methods may be embodied other than as specifically described herein. The disclosure is also defined in the following claims.

What is claimed is:

1. A surround sound system for use with a recreational vehicle (RV) comprising:
a TV having a TV screen exposed on a side of a body of the RV;
one or more speakers arranged to emit sound located at or near the TV; and
one or more speakers mounted to a retractable awning assembly and spaced from the body of the RV.

2. The surround sound system of claim 1, further comprising a sub-woofer connected to the one or more speakers.

3. The surround sound system of claim 1, wherein the one or more speakers mounted to the retractable awning assembly are mounted to a retractable frame of the retractable awning assembly.

4. The surround sound system of claim 2, wherein the retractable frame comprises openings for mounting the one or more speakers mounted to the retractable awning assembly.

5. The surround sound system of claim 2, wherein power wires for the one or more speakers mounted to the retractable awning assembly are routed inside the retractable awning assembly.

6. The surround sound system of claim 5, wherein signal wires for the one or more speakers mounted to the retractable awning assembly are routed inside the retractable awning assembly.

7. A method for creating a surround sound to an exterior of a recreational vehicle comprising:
providing a TV having a TV screen exposed on a side of a recreational vehicle;
locating at least one speaker at or near the TV; and
locating at least one speaker remote from the TV;
wherein said at least one speaker remote from the TV is located with a retractable awning assembly.

8. The method of claim 7, wherein the at least one speaker remote from the TV is located with a retractable frame at an end closer to a free end of an awning fabric than a fixed end of the awning fabric.

9. A surround sound system for use with a recreational vehicle (RV) having a retractable awning assembly, the surround sound system comprising:
a first speaker and a second speaker located at or near a side of the RV and configured to emit sound towards a surround sound region; and
a third and a fourth speaker mounted to the retractable awning assembly and configured to emit sound towards the surround sound region.

10. The surround sound system of claim 9, further comprising a sub-woofer connected to the one or more speakers.

11. The surround sound system of claim 10, wherein the third and fourth speakers are mounted near a free end of the retractable awning assembly.

12. The surround sound system of claim 11, wherein the third and fourth speakers are mounted to openings in a retractable frame of the retractable awning assembly.

13. The surround sound system of claim 9, wherein power wires for the third and fourth speakers are routed inside the retractable awning assembly.

14. The surround sound system of claim 13, wherein signal wires the third and fourth speakers are routed inside the retractable awning assembly.

15. The surround sound system of claim 9, further comprising a fifth speaker and a sixth speaker, each respectively mounted at an intermediary position along support arms of the tractable awning assembly.
